(19) United States
(12) Patent Application Publication
(10) Pub. No.: US 2012/0038989 A1
(43) Pub. Date: Feb. 16, 2012

(54) ANTIREFLECTION COATINGS INCLUDING SCATTERED OBJECTS HAVING TWO SEPARATE RANGES WITH SEPARATE REFRACTION INDICES

(75) Inventors: Melanie Louarn, pessac Cedex (FR); Vincent Gaud, Pessac Cendex (FR); Fabien Rouge, Pessac Cendex (FR)

(73) Assignee: POLYRISE, PESSAC (FR)

(21) Appl. No.: 13/120,246

(22) PCT Filed: Sep. 23, 2009
(86) PCT No.: PCT/FR2009/051802

§ 371 Date: Aug. 5, 2011

(30) Foreign Application Priority Data
Sep. 23, 2008 (FR) 0856406

(51) Int. Cl. G02B 1/11; B05D 5/06

(52) U.S. Cl. 359/580; 427/164; 427/165; 427/508

(57) ABSTRACT

The present invention relates to a surface treatment method with which anti-reflection properties toward electromagnetic radiation may be imparted to the surface of a substrate. A transparent coating toward said electromagnetic radiation is deposited on said surface, which contains in the dispersed state within said layer, objects with dimensions of less than 5 microns comprising:
a core with a first refractive index n_{C}, and
a layer, a so-called skin, surrounding the core, having a second refractive index n_{E} distinct from the refractive index n_{C} of the core
   wherein the ratio of the dimensions of the core to the dimensions of the core/skin assembly is comprised between 1:15 and 1:5.

The invention also relates to the coated substrates obtained according to this method.

The present invention relates to a method with which the optical properties of the surface of a material may be modified, by imparting to this surface anti-reflection properties. The invention in particular relates to anti-reflection coatings of this type applied on transparent substrates, notably in glass or polycarbonate, which allow an improvement in light transmission through these transparent substrates. The invention also relates to substrates coated with an anti-reflection coating, which are obtained in this context, which may typically be transparent optical devices (optical lenses for example) with optimized optical transmission.

By “a surface treatment imparting anti-reflection properties”, is meant here a modification of the surface of a solid substrate with which the reflection properties of at least certain electromagnetic waves may be reduced in the domain ranging from ultraviolet to infrared (typically having their wavelength comprised between 150 nm and 2500 nm) on the modified surface of the solid substrate. More specifically, in the sense of the present invention, the notion of “anti-reflection” treatment designates a treatment of this type which, when it is applied on a transparent substrate inhibits reflection of at least some of the electromagnetic waves for which the material is transparent, while increasing the transmission of these waves through said transparent substrate. Anti-reflection properties of this type are particularly sought in many industrial fields, notably in optics (for laser type devices for example, it is most particularly of interest to have lenses provided with transmission properties as optimized as possible).

Various surface treatments with which it is possible to impart an anti-reflection effect of the aforementioned type have been described, notably for imparting an anti-reflection effect on glass or polycarbonate substrates.

The surface treatment methods developed within this scope generally consist of depositing several successive layers having distinct refractive indexes, typically an alternation of at least three layers (generally a layer with a refractive index i₁, a layer with refractive index i₂ with and then a layer with a refractive index i₃ with i₃>i₂). For more details relating to multilayer coatings of this type, reference may notably be made to Advances in nanomaterials and processing, parts 1 and 2; Solid State America, Vol. 121-126, p. 559-562, Solar Energy Materials and Solar Cells, Vol. 90 November 2006; or else further to Patent Applications EP 1433809 and US 2004/71889,

The aforementioned anti-reflection type coatings, notably used for ensuring an anti-reflection effect on spectacle glasses, have the drawback of being awkward to apply, notably insofar that they involve the deposition of several successive layers, which is both expressed in terms of high costs and long production times. Further, each of the successive depositions is generally carried out according to methods performed in vacuo, the application of which further increases the preparation costs.

Further, the requirement of depositing several successive layers on the treated substrate leads to a final deposit with a relatively high thickness, which may be detrimental to the transmission properties (a portion of the waves being capable of being absorbed at the multilayer coating). If these absorption phenomena are relatively not very notable on spectacle glasses, they have a significantly more substantial implication in optical devices such as lasers where even a very low reduction in the transmission has very substantial repercussions on the final efficiency of the device.

An object of the present invention is to provide a novel anti-reflection treatment method which is at least as efficient, and preferably more efficient than the aforementioned multilayer coating method, and which allows more easy and less expensive modification of transparent substrates, notably based on glass or polycarbonate, in order to impart a particularly high, preferably equivalent, or even greater light transmission to them, than that obtained with the method by the aforementioned multilayer coating techniques.

For this purpose, according to a first aspect, the object of the present invention is a method for treating a surface of a substrate with which anti-reflection properties towards electromautetic radiation may be imparted to this surface, in which a transparent coating with regard to said electromagnetic radiation is deposited on said surface, which contains in the dispersed condition within said layer, objects of dimensions smaller than 5 microns, preferably smaller than 2 microns, said objects comprising at least two areas consisting of two different substrates transparent toward said electromagnetic radiation and having distinct refractive indexes, i.e.:
a core with a first refractive index n_{C}, and
a layer surrounding the core (designated as <<skin>>), having a second refractive index n_{E}, distinct from the refractive index n_{C}, of the core; where the ratio of the dimensions of the core to the dimensions of the core/skin assembly is comprised between 1:1.5 and 1:5.

The deposited coating according to the method of the present invention, and the objects which it contains, are transparent at least toward certain electromagnetic waves in the domain ranging from ultraviolet to infrared and they are in particular transparent toward waves for which the anti-reflection effect is sought. They may typically be visually transparent (i.e. transparent for all or part of visible light). Alternatively, they may only be optically transparent i.e. transparent only lot certain invisible radiations (UV and/or infrared).

According to a particular embodiment, the substrate for which the surface is modified according to the method of the present invention is a transparent substrate. This for example is a glass or polycarbonate substrate.

In the sense of the present description, a coating, an object, a material or a substrate is said to be “transparent” for electromagnetic radiation of a given wavelength λ, when it is crossed by a flux of said electromagnetic radiation, preferably without absorbing this flux or only absorbing a minority portion of this flux. A material or a substrate said to be transparent at a wavelength preferably has a molar absorption coefficient as small as possible at this wavelength, this molar absorption coefficient (also said to be a molar “extinction” coefficient) preferably being less than or equal to 200 L.mol⁻¹.cm⁻¹, and more preferentially less than or equal to 100 L.mol⁻¹.cm⁻¹, at the relevant wavelength.

The core and the skin of the objects which are present in the dispersed condition in the deposited coating according to the method of the present invention consist of substrates which are transparent notably toward the electromagnetic radiation for which the anti-reflection effixt is sought. The refractive indexes of the constitutive substrates of the core and of the skin of these dispersed objects to which reference is made in the present description, i.e. the first refractive index n_{C} of the core and the second refractive index n_{E} of the layer surrounding the core respectively, designate the refraction indexes of the substrates at the wavelength (or at the wavelengths) of the electromagnetic radiation for which the anti-reflection treatment is sought.

The transparent anti-reflection coating deposited according to the method of the present invention is preferably a single layer coating, stemming from the deposition of a single and unique layer on the surface to be modified. Typically, the deposited coating has a thickness comprised between 10 nm and 10 microns, more preferentially between 50 nm and 5 microns. Anti-reflection properties according to the invention are obtained both for thin layers of a few tens to a few hundred nanometers (for example between 10 and 900 nm, and in particular between 50 and 500 nm) and for layers with micrometric thickness (for example from 1 to 10 microns, notably from 1 to 5 microns).

Notably for anti-reflection applications aiming at increasing transmission (surface treatment of a lens typically) and in particular for anti-reflection applications of this type relating to electromagnetic radiations in the UV and/or visible range, it is generally preferable (notably for limiting any parasitic absorption phenomenon by the deposited layer) that the deposited transparent coating have a thickness of less than 1 micrometer, preferably less than 800 nm, and more preferentially still less than 500 nm, this thickness being advantageously between 10 and 600 nm, notably between 50 and 500 nm; for example between 100 and 400 nm. For anti-reflection applications relating to electromagnetic radiations in the infrared range, greater thicknesses (ranging up to a few microns) may be desirable. It should be noted on this matter that it is preferable that the size of the objects present in the deposited coating according to the invention be all the greater since the wavelength of the radiation for which the anti-reflection effect is sought, is large (typically, for electromagnetic radiation of a given wavelength λ, it is preferable that the core of the objects have dimensions greater than λ/4 and that the thickness deposited on the core be also greater than 214). Micron layers (i.e. with a thickness greater than or equal to 1 micron) are also recommended when it is desired to impart anti-reflection properties to the surface of a non-transparent material.

The objects which are dispersed within the transparent coating are isotropic or anisotropic objects preferably having dimensions of less than 2 microns, these dimensions being typically comprised between 2 nm and I micron. Notably in order that they have core and skin areas with clearly distinct refractive indexes, these dispersed objects preferably have dimensions equal to at least 3 nm, and more preferentially of at least 5 nm (these dimensions being advantageously greater than or equal to 10 nm, or even 20 nm, for example at least 50 nm). Typically, the objects which are dispersed within the transparent coating according to the invention have dimensions comprised between 10 nm and 800 nm, for example between 20 and 600 nm. These dimensions should be selected all the more smaller since the sought thickness for the transparent coating is small (the thickness of the transparent coating is generally at least equal to the dimension of the dispersed objects which it contains). Thus, for obtaining thin coating layers well adapted for increasing transmission of UV or visible radiations within a transparent material, it may typically prove to be of interest to deposit a layer where the dispersed objects have dimensions of less than 400 nm, for example less than 300 nm, inure preferentially less than 200 nm, or even less than 100 nm.

The objects Which are dispersed within the transparent coating deposited within the scope of the method of the present invention are generally formed by a core of the aforementioned type having: the first refractive index n_{c} surrounded by the skin having the second refractive index n_{E}.

Alternatively, however, the dispersed objects may comprise at least one additional coating layer around this core/skin assembly. If necessary, each of the additional coating layers is formed by a material transparent toward electromagnetic radiation for which the anti-reflection effect is sought and, preferably, each of the additional coating layers has a refractive index different from that of the layer(s) with which it is in contact.

in the objects present in the dispersed condition within the transparent coating deposited within the scope of the present invention, the skin which surrounds the core is formed by a substrate of an organic and/or inorganic nature, as well as the optional coating layer(s). Most often, the core of the objects present in the dispersed condition within the transparent coating is also itself formed by an inorganic and/or organic substrate. According to another more particular embodiment, the core may be empty (according to the specific embodiment, the dispersed objects are of the hollow particle type and the refractive index n_{C} of the core is then substantially equal to 1).

In the objects which are dispersed within the transparent coating deposited within the scope of the method of the present invention, the average thickness of the skin surrounding the cores has dimensions of the same order of magnitude than those of the core and with a ratio of the dimensions of the core to the dimensions of the core/skin assembly formed by the core having the first refractive index n_{C} surrounded by the skin having the second refractive index n_{E}, being comprised between 1:1.5 and 1:5, this ratio being advantageously of the order of 1:2.5. In the sense of the present description, the expression <<ratio of the dimensions of the core to the dimensions of the core/skin assembly>> designates the ratio of the characteristic dimension of the core to the characteristic dimension of the core/skin assembly in the case of particles of the isotropic type, or else the ratio of the characteristic dimensions of the core and of the characteristic dimensions of the core/skin assembly within the scope of anisotropic particles. Thus, within the scope of isotropic particles, this ratio may be defined as the ratio of the average diameter of the core relative to the average diameter of the core/skin assembly.

Typically, an object dispersed according to the invention may for example appear as a core of isotropic morphology (substantially spherical for example) and forming with the layer having the second refractive index n_{E} which surrounds it, a core/skin assembly of isotropic morphology (substantially spherical for example) having an average dimension d_{C+E} comprised between 2 nm and 1 micron, for example between 5 nm and 800 nm, notably between 10 nm and 500 nm, with a d_{C}/d_{C+E} ratio advantageously comprised between 1:1.5 and 1:5, for example between 1:1.8 and 1:4, and typically of the order of 1:2.5.

The dimensions of objects in the dispersed condition to which reference is made here in the present description, here refer to different dimensions as they are measured by light scattering, notably by dynamic scattering of light, for example with an equipment of the Malvern type (Zetasizer). Typically, the dimensions measured by light scattering are determined on objects in the dispersed condition. To do this, if need be, it is possible to disperse the objects for which determination of the dimensions is sought, in a suitable solvent (water, ethanol, water/ethanol mixture, tetrahydrofurane, or dimethylsulfoxide, for example, at a concentration typically ranging from 0.1 mg/l to 20 mg/l. The sample to be analyzed which contains the objects in the dispersed condition, is placed in the incident beam of a laser and scattering is measured at an angle of 90°. The dimensions measured according to this light scattering method have high resolution (typically the measurement is carried out with an accuracy to within +/−0.4 nm).

These measurements carried out with light scattering are corroborated by measurement methods using electron microscopy, which further allows access to the dimensions of the constitutive portions (core and skin notably) of the objects for which the more overall dimension is determined by light scattering. Analysis methods which are particularly suitable for accessing the dimensions of the objects in the dispersed condition and of their constitutive portions, are the electron microscope techniques of the SEM (scanning electron microscopy) and TEM (transmission electron microscopy) types, the principles of which are notably described in ASTM standards, Digital library, Chapter 72, J G Sheehan (1995).

Within the scope of the present invention, the inventors have now demonstrated unexpectedly that when transparent coatings comprising micron or sub-micron objects of the aforementioned type, i.e. having a core and a coating layer having refractive indexes n_{C} and n_{E}, are deposited on the surface of a substrate, an anti-reflection effect is obtained on the thereby treated surface by depositing this sole layer.

Without intending to be bound by a particular theory, in the light of the work carried out by the inventors within the scope of the invention, it seems possible to put forward that this anti-reflection effect is at least partly explained by the fact that each of the dispersed objects would behave as a sort of “nanodomain” having locally, a structure of the multilayer type which would make it capable to locally ensure a similar effect to that observed with usual (more macroscopic) multilayer deposits, the addition of these local effects imparting to the material particularly interesting overall anti-reflection properties.

It emerges from the experiments conducted by the inventors that the dispersion of the objects having this “local multi-layer structure” within the deposited coating ensures a similar anti-reflection effect, if not improved, as compared with the effect observed with usual multilayer deposits.

The anti-reflection coatings prepared according to the invention further have transparent properties at least similar to those of the multilayer deposits known from the state of the art. In certain cases, this transparence is even greater (indeed, insofar that they only require a single deposit as a single layer, the anti-reflection deposits according to the invention are likely to prove to be more transparent than thicker multilayer coatings where radiation absorption phenomena are more likely to occur). These transparence properties, obtained without having to apply any complicated technique, make the anti-reflection deposits of the invention a solution of choice as an alternative to multilayer coatings, with which it is possible to simply access transparent materials having a high transmission of electromagnetic waves from the UV to the infrared domain.

Moreover, insofar that it only requires the deposition of a single layer for obtaining the sought anti-reflection effect, the method of the invention proves to he less expensive and less long to apply than the method with a multilayer deposit, which further is one other of its advantages,

Although a single layer deposit is sufficient for obtaining an anti-reflection of the type sought according to the invention, according to a particular embodiment of the method of the invention, it is possible to can out several successive anti-reflection depositions (for example at least 2 or even at least 3) on the surface of the treated substrate, where at least one of the anti-reflection deposits contains in the dispersed condition, objects having the aforementioned core-skin structure. Multilayer deposits of this type may notably be used for imparting particularly pronounced anti-reflection properties and/or for ensuring an anti-reflection effect.

The aforementioned effects generally prove to be all the more pronounced since the refractive indexes n_{C} and n_{E} of the core and of the coating layer (skin) which surrounds it are different. Within this scope, it proves to be generally advantageous that at the wavelength (or at the wavelengths) of the electromagnetic radiation for which the anti-reflection effect is sought, the difference (n_{C}-n_{E}) between the refraction indexes of the core and of the coating layer which surrounds it, is in absolute value, greater than 0.01, this difference being more advantageously of at least 0.1, and still more advantageously of at least 0.2. Differences of 0.3 or more lead to even further interesting results.

The transparent coating which plays the role of a carrier of the dispersed objects in the method of the present invention may be any type of coating which may be deposited as a layer with a size of less than 10 microns, more preferentially less than 5 microns and still more advantageously of less than 1 micron. This may for example be a varnish or a polymer layer.

According to a particularly interesting embodiment this coating is a sol/gel coating. The sol/gel coatings are coatings of a well-known type, which are obtained by hydrolyzing mineral alkoxides such as silicon, titanium or zinc alkoxides, which leads to a reaction similar to polymerization of mineral species, leading in a first phase to the formation of a sol of mineral oxide particles, (silica TiO₂ or ZrO₂ for example) and then to gradual gelling of the medium, in fine leading to the obtaining of a crosslinking of the whole of the mineral species in the form of a rigid structure analogous to glass. So-called “sol/gel” depositions are depositions carried out by depositing on a substrate a layer of a reaction medium of this type, in the non-gelled or partly gelled sol condition, and then by letting gelling continue until hardening of the layer is obtained. The deposition may be carried out by any suitable conventional method, notably by the so-called, dip-coating technique or spin-coating technique which are well-known techniques notably from Process Engineering Analysis in Semiconductor Device Fabrication, S. Middlemann & A. Hochberg, Mcgraw-Hill College, p. 313 (1993), or else from the application EP1 712 296.

The deposition of an anti-reflection coating according to the invention using the aforementioned sOl/gel technique advantageously includes a heat treatment (drying) step at the end of the gelling, with which hardening of the deposited sol/gel layer may be optimized, and, hence good cohesion to the obtained, coating may be obtained in fine. This heat treatment may both be carried out with hot air and with infrared radiation. This treatment is preferably carried out by placing the substrate provided with the anti-reflection coating being formed, in an oven at a temperature comprised between 20 and 200° C., more preferentially between 50 and 150° C. According to an interesting embodiment, the heat treatment is gradually carried out by gradually raising the temperature of the deposition temperature of the sol/gel coating on the substrate (typically between 10 and 25° C.) to the heat treatment temperature (typically at least 50° C.), with a temperature rise rate typically comprised between +0.5°/minute et +5° C./minute.

When the method of the invention applies a transparent coating deposited by the aforementioned sol/gel technique, the mineral alkoxide which is used is advantageously a tetraalkoxysilane, preferably tetramethoxysilane (a compound fitting the formula Si(OCH₄)₄, generally designated by its acronym TMOS, and sometimes designated as tetramethylorthosilicate) or else further tetraethoxysiiane (or TEOS, of thrmula Si(OC₂H₅)₄). In a particularly preferred way the mineral alkoxide used is tetramethoxysilane TMOS. Alternatively, the mineral alkoxide which is used, may be a titanium alkoxide (isopropoxide titanate) or else a zinc alkoxide (such as zinc isopropoxide).

According to a particular embodiment, which generally proves to be interesting, the transparent coating which plays the role of a carrier of the dispersed objects in the method of the present invention may advantageously be a particular coating of the sol/gel type, obtained from a mixture comprising initially (i) at least one mineral alkoxide, preferentially of the aforementioned type and (ii) at least one UV-crosslinkable monomer or crosslinkable under the effect of a heat treatment (typically in the presence of a source of free radicals). In this case, a coating is generally obtained having particularly high cohesion, insofar that the synthesis of the coating then includes a dual hardening degree, i.e.:
a first hardening is obtained by hydrolysis and, condensation of the mineral alkoxide according to the sol/gel technique; and
together and/or complementarily, additional hardening occurs by crosslinking of the crosslinkable monomer(s), typically under the effect of UV irradiation and/or heating depending on the exact nature of the monomers to be crosslinked.

The crosslinkable monomers which may be used according to this specific alternative of the method of the invention may be non-polymerized monomeric species bearing functions capable of making them UV- or heat-crosslinkable. Alternatively, these may be macromolecular species such as oligomers or polymers bearing functions capable of making them UV- or heat-crosslinkable. The UV-crosslinkable monomers or crosslinkable via a thermal route, used according to this embodiment, are typically compounds bearing methacrylate, acrylate, epoxy or vinylether groups. Alternatively, it is possible to use mixtures of two types of monomers bearing complementary functions which react with each other when they are in contact in order to crosslink by condensation (within the scope of this alternative, it is for example possible to use the following pairs of reactive functions: epoxy/amme; acrylate/amine, isocyanate/alcohol; thiol/ene; or epoxy/isocyanate,

Generally, when the transparent coating used in the method of the present invention is of the sol/gel type, it is preferable that this sol/gel coating be synthesized in the presence of at least one surfactant, in particular of the type described in Sol-Gel Sciences: Sol-Gel: The Physics and Chemistry of Sol Gel Processing, C. Jeffrey Brinker and George W Scherer, Academic Press (1990) or in the Journal of Colloids and Interface Science, Vol. 274, Issue 2, 355-361. The use of this type of surfactant allows limitation of the size of the particles in the sol obtained by hydrolysis of the alkoxide and thus allows control of the thickness of the coating layer obtained in fine. As a very suitable surfactant within this scope, mention may notably be made of polyoxyethylene surfactants (polyoxyethylene esters in particular), such as TWEEN 85, for example.

Another means allowing the size of the formed particles to be controlled in the sot made by hydrolysis of the mineral alkoxide used in the sol/gel, consists of using a mixture of alkoxides comprising alkoxides having 4 hydrolyzable groups and alkoxides having at most 3 hydrolyzable groups (for example two, or even one). Within this scope, the sol/gel coating may typically be synthesised by using as a mineral alkoxide, a mixture of alkoxides comprising:
at least one silane having hydrolyzable groups (such as teuaniethoxysilane TMOS, or tetraethoxysilane TEOS); and
at least one silane having less than 4 hydrolyzable groups, this silane preferably fitting the formula RₙSiX₄₋ₙ, wherein:
   n is an integer equal to 1, 2 or 3;
   each of the groups R, either identical or different, designates an optionally functional, non-hydrolyzable organic group, and
   X is a hydrolyzable group (typically an halogen-alkoxy group, for example a trimethoxysilane, triethoxysilane, γ-propyltrimethoxysilane, γ-propyltriethoxysilane, γ-aminopropyl-trimethoxysilane, γ-aminopropyl-triethoxysilane, γ-mercaptopropyl-trimethoxysilane, γ-mercaptopropyl-triethoxysilane, γ-(meth-)acryl-oylpropyl-trimethoxysilane, γ-(meth-)acryloylpropyl-triethoxysilane, γ-glycidoxypropyl-trimethoxysilane, γ-glycidoxypropy-triethoxy-silane, di-methoxysilane, di-ethoxysilane, polydimethylsiloxane α-ω-disilanol, or polydiethylsiloxane α-ω-disilanol; or a halogen group such as —Cl or —Br:

According to this embodiment, it is possible to use for example silanes bearing a single hydrolyzable group, or precursor compounds of such monofunctional silanes, for example compounds producing a mono-functional silane following a hydrolysis reaction, such as for example 1,1,1,3,3,3-hexamethyl-disilazane (IIMDS) or further chlorosilanes such as trimethylchlorosilane.

On the other hand when a sol/gel process is applied for making a coating according to the invention, the synthesis medium of this coating comprises water, optionally associated with one or more water-miscible solvents (for example ethanol). The water is then preferably present in an amount equivalent to half of the hydrolyzable silane functions in the sollgel. formulation.

Regardless of the nature of the transparent coating which plays the role of a carrier of the dispersed objects in the method of the present invention, the objects which it contains, advantageously have the preferential characteristics of one of the 3 alternatives defined hereafter.

According to a first alternative of the invention, the core of the objects present within the transparent coating deposited on the substrate to be treated according to the invention is of organic nature.

Within the scope of this first alternative of the invention the core may for example comprise or consist of:
at least one linear or (advantageously) branched hydrocarbon polymer, he chains of which optionally bear hetero-atoms; or
at least one component or a mixture of components having a lose molar mass, typically less than 250 g/mol, for example solvents or oily bodies.

Within the scope of the first alternative defined above, the layer (skin) surrounding the organic core is typically a polymer layer, which may typically be formed around the organic core by techniques of polymerization in an emulsion, in a dispersion, in a mini-emulsion or of spontaneous emulsion. These techniques and their application method are known to one skilled, in the art. For more details relating to them, reference may for example be made to Soft Matter, Vol. 2, pp. 940-949 (2006) or to Chem. Phys. Chem. Vol, 6, pp 209-215 (2006).

The objects with a core/skin structure obtained according to the first alternative of the invention are typically capsules (most often but not necessarily spheroidal capsules) which comprise a polymer shell, making up the skin, confining an organic core material, preferably of the aforementioned type (a polymer distinct from the polymer of the skin or non-polymeric organic compounds, for example). Regardless of their exact structure, these objects typically have dimensions between 50 nm and 2 microns, these dimensions being preferably less than 1 micron and more advantageously less than 800 nm, or even less than 500 nm.

Objects with a core/skin structure according to the first alternative of the invention may for example be capsules comprising a skin of polyurethanes or polyamides surrounding a core of hexadecane.

Other interesting objects with a core/skin structure according to the first alternative of the invention comprise two polymers of the same type as a core polymer and a skin polymer (for example two methacrylates) with one of the polymers bearing specific groups which are not borne by the other polymer (fluorine groups —F, for example), In this case, as the core/skin structure is typically obtained by carrying out polymerization of the corresponding monomers, initially starting with a polymerization medium only containin the monomers leading to the formation of the core polymer (for example not bearing specific groups), and then enriching the polymerization medium with the monomers leading to the formation of the skin polymer (for example bearing specific groups), Objects with a core/skin structure which may be used according to the first embodiment may for example be of the type of copolymers of butyl acrylate and of trifluoroethylmethyl methacrylate as described in Macromotecules, Vol. 30, 123-129 (1997).

Other objects with a core/skin structure which may be used accordingto the first alternative of the invention are self-assemblies of sequenced polymers with a diblock structure comprising a first block having affinity fora given solvent, bound to a second block having less strong affinity and preferably no affinity for said solvent. When these polymers are introduced within the solvent, they self-assemble in the form of an object of the core/skin type (the blocks having strong affinity for the solvent forming an outer layer surrounding an internal core where the blocks having less strong affinity for the solvent are grouped, Examples of sequence copolymers leading to this type of self-association in a solvent medium have in particular been described in Langmuir, Vol. 22, pp. 4534-4540 (2006) (poly(ethylene oxide) block-(N,N-diethylaminoethyl methacrylate) block) or Adv. Funct. Mater., Vol. 16, pp. 1506-1514 (2006) (sequenced diblock copolymers of the polyoxyethylene block-poly(E-caprolactoni.) block type). The sequenced polymers described in these documents assemble together when they are placed in a solvent medium in order to form objects comprising a core based on one of the sequenced polymers and a skin based on the other sequenced polymer.

According to a second alternative of the invention, the core of the objects present within the transparent coating deposited on the substrate to be treated according to the invention is of inorganic nature.

Within the scope of this second alternative of the invention, the core may for example comprise or consist of one or more of the following materials:
a mineral oxide, notably silica or a metal oxide
a metal sulfide
metal nitride
a metal halide
a metal.

More preferentially, the inorganic core of the objects according to the second alternative consist of silica, metal oxides, metal sulfides and/or metals, still more preferentially silica, metal oxides (TiO₂ or alumina, notably) or metals (gold, silver for example).

Within the scope of this second alternative, according to a first embodiment, the layer (skin) surrounding the inorganic core is a polymer layer, this polymer skin may then be prepared according to two great access routes, i.e.

(1) The So-Called “Grafting onto” Type Methods

According to this first approach, one begins with pre-existing inorganic cores (typically inorganic colloidal particles) and pre-existing polymer chains are immobilized (or pre-existing grafts) on the surface of these inorganic cores. To do this, the polymeric chains or grafts for which immobilization is desired generally bear chemical functions capable of generating a covalent or electrostatic bond with the surface of the inorganic cores or with a group present on the surface of the cores.

For example it is possible to start with colloidal gold particles and to graft on them polymeric chains bearing a thiol termination, for example according to the method which was for example described in J. Am. Chem. Soc., Vol. 120, 12696 (1998), wherein α-methoxy-ω-mercapto-poly(ethylene glycol)polymers are grafted on gold particles.

2) The So-Called “Grafting, from” Type Methods

According to this second approach, polymeric chains are grown from functionalized core particles bearing organic groups.

A method which is widely used within this scope consists of initiating polymerization from inorganic cores (preferably colloidal particles) modified at the surface with groups initiating polymerization. Advantageously, the functional groups introduced on the surface of the inorganic cores are control agents allowing controlled radical polymerization reaction of the ATRP type. For example, gold particles functionalized with thio groups may be used. Brominated polymerization initiators may be grafted by the method with exchange of ligands, and polymerization may be initiated in the presence of monomers such as (meth)acrylic monomers (methyl methacrylate, ethyl methacrylate, ethyl acrylate, , , ) according to the method for example described in Angew. Chem. Int. Ed., 40, 4016 (2001) or else further in Macromol. Chem. Phys., 1941-1946 (2005). The objects obtained according to the method of this second article (gold core covered with poly(N-isopropylaerylamide)) are particularly well adapted according to the invention for giving an anti-reflection effect on the surface of a substrate in the infrared range.

The synthesis of a polymeric skin by ATRP may also be used on inorganic cores of mineral oxides, in particular inorganic cores of silica or titanium oxide (as colloidal particles notably), for example according to methods of the type described in Materials Letters, Vol. 62, Issue 8-9, (2008), or in Composites Science and Technology, Vol. 66, Issue 9, July 2006.

It is also possible to graft the polymeric chains on the surface of preformed inorganic objects advantageously bearing —OH and/or —SH functions (thio-functionalized gold particles for example) from polycondensation reactions (for example between a dithiol and a diester), by advantageously putting into contact preformed inorganic objects bearing —OH and/or —SH functions with:
monomers, including reactive groups including:
(i) at least one group including an α-β unsaturated carbonyl group C═C—C═O (for example an acrylic, methacrylic or acrylamide group) and/or an α-β unsaturated thiocarhonyl group C═C—C═S; and/or
(ii) at least one heterocyclic group comprising 3 to 5 links (preferably 3 or 4 links), selected from cyclic ethers, cyclic thioethers and aziridine cycles, this heterocyclic group preferably being at least one epoxy, thioepoxy or aziridine group, and more preferentially at least one epoxy or thioepoxy group; and/or
(iii) at least one group selected from isocyanate groups —N═C═O or thioisocyanate —N═C═S, and trivalent groups of formula >C═CZ-, wherein Z is an electron attracting group (for example a 4-nitrophenyl, cyano group —C═N—);

and
a catalyst (C) bearing at least one conjugate guanidine function, prefer bearing a conjugate his-guanidine function fitting the following thrmula (1):

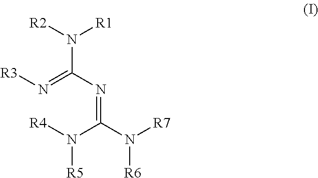

wherein each of the groups R1 to R7 represents independently of the other groups:
a hydrogen atom; or
a cyano group —CN; or
a linear or branched, saturated or unsaturated., carbon chain, optionally cyclized either totally or partly, optionally substituted, and optionally interrupted by one or more hetero-atoms (O, S, N, P or Si, for example) and/or by groups bearing hetero-atoms such as carboxy, amide, or carbamate groups (for example by divalent groups —C(═O)O—, —OC(═O)—, —O—C(═O)—O—, >N—C(═O)—, —C(═O)—N<, >N—C(═O)—O—, —O—C(═O)—N<, —N═C—, this chain being typically:
an either linear or branched alkyl, ’,likely' or alkynyl group, advantageously comprising from 1 to 12 carbon atoms, for example from 1 to 6 carbon atoms, this alkyl, alkenyl or alkylnyl group being optionally substituted for example with an alkoxy group;
a cycloalkyl group advantageously comprising from 6 to 18 carbon atoms, optionally substituted for example with at least one alkyl or alkoxy group;
an aryl group advantageously comprising from 6 to 18 carbon atoms, optionally substituted, for example with at least one alkyl or alkoxy group;
a heterocycle, optionally aromatic, comprising one or more atoms selected from S, O or N;
an alkylaryl or arylalkyl group advantageously comprising from 8 to 18 carbon atoms, wherein the aryl portion is optionally substituted, notably with an alkyl or alkoxy group;
an ester, amide or carbamate group; or
a polymeric chain, optionally bearing other guanidine groups (preferably conjugate guanidine groups, if required).

The catalyst used preferably fits the formula below:

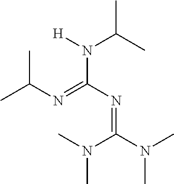

The inorganic cores based on a metal oxide, metal sulfide, metal nitride, metal halide or metal oxides may also be covered (encapsulated) with a polymeric skin by any customary emulsion or dispersion synthesis method, in particular according to emulsion or dispersion radical synthesis methods.

More generally, it is also possible to generate a skin in an emulsion notably by polymerization metathesis, by any other suitable encapsulation method for example according to the method described in Solt Matter, Vol. 2, pp. 940-949 (2006).

According to another interesting embodiment of the second alternative applying cores of an inorganic nature, the layer (skin) surrounding the inorganic core consists of an inorganic material distinct from the one present in the core, this material forming the skin then comprising typically an oxide or a sulfide. In this case, it is preferable that the core consists of metal oxide, metal sulfide or metal.

Commercial products having a core and a skin of the metal oxide type are marketed, for example by Ibu-Tech (Germany), who proposes for example ZnO/SiO₂ compositions, the global size of ‘Which is 40 nm, under reference NA403.

As an example of particles which may be used according to the invention mention may be made of particles with a gold core and a silica skin obtained as in the article published in the Journal of Nanopartiele Research, 8, 1083-1087 (2008), with an inverse emulsion technique involving the formation of NH₄AuCl₄AuCl₄ micelles covered with an obtained protective silica layer, and then reduction of a gold salt within the micelles.

According to a third alternative of the invention, which is more specific, the core of the objects present within the transparent coating deposited on the substrate to be treated according to the invention is a hollow cavity, typically filled with air, having a refractive index substantially equal to 1, this cavity having dimensions advantageously of less than 1 micron, and preferably greater than 20 nm, for example between 50 and 500 nm.

According to this third alternative, the layer (skin) surrounding the core typically consists of an inorganic material. Most often, the objects present within the transparent coating are typically hollow mineral particles, for example hollow particles of silica or mineral oxide, said to be of the “hollow spheres” type, for example obtained by microemulsion or precipitation of colloidal particles around texturation agents (“templates”), notably according to the methods described in Materials Chemistry and Physics, Vol 111, Issue 1, (2008) or Materials Letters Vol. 62, Issue 24, (2008).

According to another aspect, the present invention relates to substrates having a surface with anti-reflection properties as obtained according to the method of the present invention. Within this scope, the object of the invention is notably transparent substrates having a surface with anti-reflection properties according to the invention, which have particularly interesting transmission properties.

The substrates, the surface properties of which are modified in order to give them an anti-reflection effect according to the method of the invention, may vary to a very large extent. These are advantageously transparent materials, but according to a particular embodiment, they may also be non-transparent substrates, As examples of substrates, either transparent or not, the surface of which may be modified according to the method of the invention, mention may notably be made in a non-limiting way of:
supports in organic materials, for example in plastic materials, advantageously transparent for example in polycarbonate;
supports in organic materials such as for example:
   glass supports or more generally based on mineral oxides such as for example silica and its derivatives, (quartz, indium and tin oxide . . . ) or supports in metal (such as titanium supports)
   silicon supports.

Moreover, it should be noted that the surface of the substrate modified according to the invention does not have to be planar so that the deposit may be deposited thereon in an effective way: Indeed, the sot/gel deposition techniques of the type described earlier in the present description allow homogeneous and effective deposits on quasi the whole surface geometry. Thus, the substrate, the surface of which is modified according to the method of the invention, may appear as a bulky material, the shape of which is of no importance. This may for example be a plate, a lens, a moulded part.

The transparent substrates with a modified surface, obtained according to the method of the present invention, find many applications, notably in the field of optics and or ophthalmia (spectacle glass . . . ), or further in the making-up of display systems (LCD screens), solar cells, for elements of outdoor architectures (shop fronts for example).

According to a possible embodiment the substrates modified according to the invention may comprise layers other than the transparent coating ensuring the anti-reflection effect. In particular, the substrate may for example be coated with one or several sub-layers of the hard-coat type, according to means known per se before making the coating according to the invention.

Various aspects and advantages of the invention will further become apparent from the examples hereafter, where hybrid silica-polyester particles, which have a silica core with a diameter equal to 80 nm, covered with a po eric skin of 200 nm are applied as dispersed objects.

These hybrid particles, designated as “hybrid material HR1” hereafter, applied in the whole of the Examples I to 4 hereafter, were prepared according to the procedure described below:

### Synthesis of the Hybrid Material HR1

With intensive stirring, an aqueous dispersion of 20% by mass of silica particles with a size equal to 15 nm (Sigma Aldrich) was formed.

While maintaining the stirring, a silane (tetramethoxysilane TMOS) was introduced into the thereby produced dispersion at 40° C. in an amount of 50% by mass based on the mass of the silica present in the reaction medium, in the presence of a basic catalyst (ammonia), and then 0.6 molar equivalent (based on the introduced amount of TMOS) of a dihydroxylated precursor dissolved in ethanol (intended to improve <<the adherence>> of the polymer layer on the silica cores).

The dihydroxylated precursor used was prepared by producinw, an equimolar mixture of iscoyanatopropyltriethoxysilane and diethanolamine, in the presence of dibutyl-tin dilaurate, at a temperature of 50° C. Trimethylopropane (TMP) and dimethylsuccinate (DMS) were then added to this reaction medium, each in an amount of 8 molar equivalents relatively to the TMOS.

The medium was left to evolve for a few minutes, and. then the solvents present (water and ethanol) were evaporated in vacuo at 95° C. Particles of silicas with a size substantially equal to 80 nm were thereby obtained.

A bis-guanidine catalyst fitting the following formula:

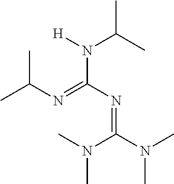

was then introduced into the medium at 40° C. and under high vacuum (-filar).

The introduction of this catalyst induced polycondensation of TMP and of DMS present in the reaction medium, whereby a polymeric skin (of the polyester type) was generated around the silica particles.

The thereby obtained core/skin type structure was then modified in order to make it dispersible (in water or in the monomers), For this purpose, the functionalization of the surface of the obtained objects with methacrylate functions was conducted, by adding to the obtained particles methyl methacrylate in an amount of 1.2 molar equivalent relatively to the TMP (at 40° C. in a vacuum of −1 bar).

At the end of these different treatments, the hybrid material HR1 was obtained as a powder comprising hybrid silica-polyester particles, having a silica core with a diameter equal to 80 nm, covered with a polymeric skin of 200 nm.

### EXAMPLE 1

In a flask, at room temperature (25° C.), 0.340 g of distilled water, 6.053 g of ethanol and 30 mg of hydrochloric acid (37%) marketed by Sigma Aldrich under the reference 310331 were mixed, and then a mixture of 1.446 g of TMOS (tetramethylorthosilicate with a purity equal to 99%, marketed by Sigma Aldrich under the reference 218472) and of 0,076 g of MPTS (3-(methacryloxy)propyltrimethoxysilane, with a purity equal to 97%, marketed by ABCR under the reference AB117674) was added.

The flask was then obturated and the mixture was left to react at room temperature (25° C.) and with stirring for 4 hrs.

A solution containing 0.152 g of the aforementioned silica-polyester hybrid material HR1, dissolved in a mixture of 0.038 g of distilled water and 0.673 g of absolute ethanol was then added to the reaction medium.

The thereby obtained medium was left with stirring at room temperature (25° C.) for 1 hr, and then kept at room temperature for 20 hrs.

70 μL of the composition obtained at the end of these different steps (a partly gelled sol) were deposited on a surface of a transparent planar polycarbonate plate, of 2.5 cm×2.5 cm and with a thickness equal to 0.4 cm. The polycarbonate which was used within this scope is an anti-UV treated polcarbonate of the brand. MakroIon, marketed by Bayer.

Deposition of the composition on the plate was carried. out according to the centrifugal coating technique (spin-coaling), by rotating the plate at a speed of 2,000 revolutions/second for 10 seconds, immediately after having deposited the sol on this plate, whereby a continuous, homogeneous and transparent coatin was obtained on the surface of the plate.

The polycarbonate plate provided with the thereby achieved deposit was then placed in an oven and was subject to the following heat treatment:
1 hr at 30° C.
1 hr at 50° C.
1 hr at 70° C.

The deposition of a 290 nm coating layer was thereby achieved on the polycarbonate surface.

This coating of the polycarbonate plate decreases the reflection properties of the plate (anti-reflection treatment), which is demonstrated by measuring the light transmission through the plate before and after treatment. In this example, the treatment of the plate induces a +2.9% increase in the transmission of radiation with a wavelength equal to 550 nm through the plate.

### EXAMPLE 2

In a flask, at room temperature (25° C.), 0.340 g of distilled water and 6.053 g of ethanol were mixed and then a mixture of 1.446 g of TMOS, 0.076 g of MPTS and 0.152 g of tetrahydrofurfiiryl methacryalate (marketed by Sartomer Europe under the reference SR203) was then added.

The flask was obturated and the mixture was left to react at room temperature (23° C.) and with stirring thr 4 hrs.

A solution containing 0.152 g of the aforementioned silica-polyester hybrid material HR1 , dissolved in a mixture of 0.038 g of distilled water and 0.673 g of absolute ethanol, as well as 0.009 g of Irgacure 184 (a radical photo-initiator marketed by Ciba) was then added to the reaction medium.

The thereby obtained medium was left with stirring at room temperature (25° C.) for 1 hr, and then kept at room temperature for 20 hrs.

70 μL of the composition obtained at the end of these different steps were then deposited on a surface of a transparent planar polycarbonate plate under the same conditions as in Example 1. (deposition with the spin-coating technique) and then the polycarbonate plate provided with the thereby achieved deposit was placed. in an oven and was subject to the following heat treatment:
1 hr at 30° C.
1 hr at 30° C.
1 hr at 70° C.

The polycarbonate substrate coated with the hardened film stemming from the heat treatment was then irradiated with a Fusion F300S lamp equipped with a bulb U, by having the substrate pass under the lamp at a speed of 3talinin (which corresponds to an energy of 1.7 J/cm² in UV-A (320-390 nm) and 1.3 J/cm² in UV-V (395-445 nm))

Deposition on the polycarbonate surface of a hardened and. crosslinked coating layer with a thickness of 290 nm was thereby achieved.

This coating is an anti-reflection treatment, with a 1-2.9% increase in the transmission of radiation with a wavelength equal to 570 nm through the plate,

### EXAMPLE 3

In a flask, at room temperature (25° C.), 0.340 g of distilled water containing 2% by mass of Tween 85 and 6.053 g of ethanol were mixed and a mixture of 1.446 g of TMOS, 0.076 g of MPTS, 0.009 g of lrgacure 181 and 0.152 g of tetrahydrofurfuryl methacrylate (marketed by Sartomer Europe under the reference SR203) was then added. The flask was obturated and the mixture was left to react at room temperature (25° C.) and with stirring for 4 hrs.

A solution containing 0.152 g of the aforementioned silica-polyester hybrid material HR1, dissolved in a mixture of 0.038 g of distilled water and 0.673 g of absolute ethanol was then added to the reaction medium.

The thereby obtained medium was left with stirring at room temperature (25° C.) for 1 hr, and then kept at room temperature for 20 hrs.

70 μL of the composition obtained at the end of these different steps were then deposited on a surface of a transparent planar polycarbonate plate under the same conditions as in Example 1 (deposition with the spin-coating technique), and the polycarbonate plate provided with the thereby achieved deposit was then placed in an oven and subject to the following heat treatment:
1 hr at 30° C.
1 hr at 50° C.
1 hr at 70° C.
1 hr at 70° C.

The polycarbonate substrate coated with the hardened film from the heat treatment was then irradiated with a Fusion F300S lamp equipped with a bulb H, by having the substrate pass under the lamp at a speed of 3 m/min.

The deposition on the bicarbonate surface of a coating layer having a thickness of 310 nm was thereby obtained.

This coating provides an anti-reflection treatment, with a +3.2% increase in the transmission of radiation with a wavelength equal to 620 nm through the plate.

### EXAMPLE 4

In a flask, at room temperature (25° C.), 0.340 g of distilled water and 6.053 g of ethanol were mixed and a mixture of 1.446 g of TMOS, 0.076 g of MPTS, 0.009 g of Irgacure 184 and 0.152 g of tc.q.rahydrofitrfuryl methacrylate (marketed by Sartomer Europe under the reference SR203) was then added.

The flask was obturated and the mixture was left to react at room temperature (25° C.) and with stirring for 2 hrs.

0.046 g of HMDS (1,1,1,3,3,3-hexamethyldisilazane of purity 99% marketed by ABCR under the reference AB109172) was then added to the medium and again the mixture was left to react at room temperature (25° C.) and with stirring for 2 hrs.

A solution containing 0.152 g of the aforementioned silica-polyester hybrid material HR1, dissolved in a mixture or 0.038 g of distilled water and 0.673 g of absolute ethanol, was then added. to the reaction medium.

The thereby obtained medium was left with stirring at room temperature (25° C.) for 1 hr, and then kept at room temperature for 20 hrs.

70 μL of the composition obtained at the end of these different steps were then deposited on a surface of a transparent planar polycarbonate plate under the same conditions as in Example 1 (deposition with the spin-coating technique), and then the polycarbonate plate provided with the thereby achieved deposit was placed in an oven and subject to the following hear treatment:
1 hr at 30° C.
1 hr at 50° C.
1 hr at 70° C.
1 hr at 70° C.

The polycarbonate substrate coated with the hardened film from the heat treatment was then irradiated with a Fusion F300S lamp equipped with a bulb H, by having the substrate pass under the lamp at a speed of 3 m/min.

This coating ensures an anti-reflection effect with a increase of the light transmission through the polycarbonate plate of +3% at 690 nm and of +2.6% at 435 nm.

### EXAMPLE 5

In this example, an anti-reflection coating was made on a transparent planar polycarbonate plate similarly to the coating made in Example 3, with the difference that the substrate of the polycarbonate was coated beforehand with a <<hard-coat>> type coating deposited on the plate with the dip coating technique.

This hard-coat was made by using a commercial varnish of the polysiloxane type, marketed by the Korean corporation Gaema Tech under the commercial reference Mexmer TE 0801P.

The polycarbonate plate was immersed in the hard-coat varnish for 5 seconds at 20° C., and then removed at a speed of 5 min/s. Thermal drying was then applied in an oven at 120° C. for 1 hr.

Once this hard-coat was deposited and heat-treated, an anti-reflection coating was made on the substrate by immersing for 5 seconds the plate coated with the hard-coat in composition C3 of Example 3, stabilized at 20°.

The substrate was then withdrawn out of the composition at a speed of 0.5 mm/s, and then the plate provided with the thereby achieved deposit was placed in an oven and was subject to the following heat treatment:
1 hr at 30° C. and then
1 hr at 50° C. and then
1 hr at 70° C.

The polycarbonate substrate thereby coated with the hard-coat and the anti-reflection coating was irradiated with a Fusion F300S lamp equipped with a bulb H, by having the substrate pass under the lamp at a speed of 3 m/min.

This coating ensures an anti-reflection effect with an increase in the light transmission through the polycarbonate plate of -F-5% at wavelengths from 470 to 800 nm.

### COMPARATIVE EXAMPLE

For comparison purposes, a deposit of PMMA (Poly Methyl MethAcrylate) was made on a transparent planar polycarbonate plate as used in the previous examples.

The deposition of the PMMA was carried out as follows.

A PMMA varnish was prepared by dissolving 1.3 g of a PMA polymer with molecular masses Man=77 000 g/mol and Mw=10 000 g/mol, (marketed by Interchim) in toluene (pure grade, Xilab). The dissolution was carried out with magnetic stirring for 10 minutes. (A transparent solution was obtained).

100 μL of thereby obtained PMMA varnish was then deposited on the planar polycarbonate surface under the same conditions as in Example 1 (deposition with the spin-coating technique) and then the polycarbonate plate provided with a deposit was left at room temperature (25° C.) for 2 hrs.

The thereby PMMA homogeneous coating ensures an anti-reflection effect with an increase in the light transmission through the polycarbonate plate of +2,4% at 800 nm and of +1.6% at 540 nm

This anti-reflection effect in the visible domain, due to the refractive index of PMMA (1.49) is less marked than the anti-reflection properties obtained within the scope of Examples 1 to 4. This example actually brings to light the specific anti-reflection effect obtained, according to the invention and notably actually demonstrates that the effect obtained according to the invention is not due to the overall refractive index of the deposited layer (1.47 within the scope of Example 3 ‘Which is close to the value of 1.49 of the present example) but with the <<local multi-layer structure>> achieved within the scope of the invention.

1. A method for treating a surface of a substrate with which anti-reflection properties toward an electromagnetic radiation may be imparted to this surface, wherein a transparent coating toward said electromagnetic radiation is deposited on said surface, which contains in the dispersed condition within said layer objects with dimensions of less than 5 microns, preferably less than 2 microns, said objects comprising at least two areas consisting of transparent substrates toward said electromagnetic radiation and have distinct refractive indexes, i,e.:
a core having a first refraction index c_{C}, and
a layer, a so-called skin, surrounding the core, having a second refractive index n_{E}, distinct from the refraction index n_{C} of the core,
wherein the ratio of the dimensions of the core to the dimensions of the core/skin assembly is comprised between 1:1.5 and 1:5.

2. The method according to claim 1, wherein the substrate, the surface of which is modified, is a transparent substrate for example a glass or polycarbonate substrate.

3. The method according to claim 1, wherein the deposited transparent coating is a single layer coating, preferably having a thickness ranging from 10 nm to 10 microns.

4. The method according to claim 1, wherein, in the dispersed objects:
the core has dimensions comprised between I ran and 800 nm, and
the core/skin assembly formed by the core having the first refractive index n_{C} surrounded by the layer surrounding the core having the second refractive index n_{E} has dimensions comprised between 2 nm and 1 micron; and
the ratio of the dimensions of the core to the dimensions of the core/skin assembly being comprised 1:1,5 and 1:5,

5. The method according claim 1, wherein difference (n_{C}-n_{E}) between the refractive indexes of the core and of the coating layer which surrounds it, is in absolute value of at least 0.01, preferably at least 0.1.

6. The method according to claim 1, wherein the transparent coating is a varnish or a polymeric layer.

7. The method according to claim 1, wherein the transparent coating is a sol/gel coating, obtained by hydrolysis of a mineral alkoxide.

8. The method according to claim 7, wherein the sol/gel coating is obtained from a mixture initially comprising (i) at least one mineral alkoxide and (ii) at least one UV-crosslinkable monomer or crosslinkable under the effect of a heat treatment.

9. The method according to claim 7, wherein the sol/gel coating is synthesized in the presence of at least one surfactant.

10. The method according to claim 7, wherein the sol/get coating may typically be synthesized by using as a mineral alkoxide a mixture of alkoxides comprising:
at least one silane having 4 hydrolyzable groups; and
at least one silane having less than 4 hydrolyzable groups, this silane preferably fitting the formula RₙSiX₄₋ₙ,
wherein:
n is an integer equal to 1, 2, or 3;
each of the groups R, either identical or different, designates a non hydrolyzable organic group, and
X is a hydrolyzable group.

11. The method according to claim 1, wherein the core of the objects present within the transparent coating deposited on the substrate to be treated according to the invention, is of organic nature, and wherein the layer (skin) surrounding said organic core is a polymer layer.

12. The method according to claim 1, whreein the core of the objects present within the transparent coating deposited on the substrate to be treated according to the invention is of inorganic nature, and wherein the layer (skin) surrounding said organic core is a polymer layer.

13. The method according to claim 1, wherein the core of the objects present within the transparent coating deposited on the substrate to be treated according to the invention is of inorganic nature, and wherein the layer (skin) surrounding said organic core consists of an inorganic material distinct from the one present in the core.

14. The method according to claim 1, wherein the core of the objects present within the transparent coating deposited on the substrate to be treated according to the invention is a hollow cavity and wherein the layer (skin) surrounding said organic core consists of an inorganic material.

15. A substrate having a surface with anti-reflection properties, which may be obtained according to the method according to claim 1.
